(19) United States
(12) Patent Application Publication
(10) Pub. No.: US 2025/0098025 A1
(43) Pub. Date: Mar. 20, 2025

(54) METHOD, DEVICE, AND SYSTEM FOR DATA TRANSMISSION IN WIRELESS NETWORKS

(71) Applicant: ZTE Corporation, Shenzhen (CN)

(72) Inventors: Zhuang LIU, Shenzhen (CN); Dapeng LI, Shenzhen (CN); Yin GAO, Shenzhen (CN)

(73) Assignee: ZTE Corporation, Shenzhen (CN)

(21) Appl. No.: 18/883,083

(22) Filed: Sep. 12, 2024

Related U.S. Application Data
(63) Continuation of application No. PCT/CN2022/108687, filed on Jul. 28, 2022.

(51) Int. Cl. H04W 76/28; H04W 76/10; H04W 92/24

(52) U.S. Cl. CPC H04W 76/28; H04W 76/10; H04W 92/24

(57) ABSTRACT

This disclosure relates generally to a method, device, and system for congestion control in a wireless network. One method performed by a first network element is disclosed. The method may include providing, to a second network element, a DTX configuration for a cell associated with the second network element; providing, to a wireless device served by the cell and based on the DTX configuration, a CDRX configuration for the wireless device; and transmitting data to the wireless device according to the DTX configuration.

### TECHNICAL FIELD

This disclosure is directed generally to wireless communications, and particularly to a method, device, and system for data transmission in a wireless network.

### BACKGROUND

Controlling power consumption and reducing energy cost is critical for developing and deploying a wireless communication network. Energy saving technology is critical for achieving this goal. With the development of wireless communication technology, more and more elements and functionality are added which increases the complexity for power control. It is critical to have the capability to control the power consumption at various network elements, such as base station and UE, and yet still meet performance requirement. It is also beneficial to be able to develop power control strategy at a base station targeting different levels.

### SUMMARY

This disclosure is directed to a method, device, and system for data transmission in a wireless network.

In some embodiments, a method performed by a first network element is disclosed. The method may include: providing, to a second network element, a Discontinuous Transmission (DTX) configuration for a cell associated with the second network element; providing, to a wireless device served by the cell and based on the DTX configuration, a Connected mode Discontinuous Reception (CDRX) configuration for the wireless device; and transmitting data to the wireless device according to the DTX configuration.

In some embodiments, a method performed by a first node in a network element is disclosed. The method may include: receiving, from a second node in the network element, a first message comprising a DTX configuration for a cell managed by the network element; and transmitting data to a wireless device, via a relay of a DU of the network element and according to the DTX configuration, the wireless device being served by the cell.

In some embodiments, a method performed by a first base station a first base station is disclosed. The method may include: providing, to a core network, a DTX configuration for a cell in the first base station; and receiving data for a wireless device served by the cell from the core network based on the DTX configuration.

In some embodiments, a method performed by a first base station a first base station is disclosed. The method may include: providing, to a second base station, a DTX configuration for a cell in the first base station; receiving data for a wireless device served by the cell from the second base station, the data being transmitted by the second base station based on the DTX configuration; and transmitting the data to the wireless device based on the DTX configuration.

In some embodiments, there is a network element or a network node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows exemplary Discontinuous Transmission (DTX) configuration and Connected mode Discontinuous Reception (CDRX) configuration.

FIGS. 5A and 5B show exemplary message flows for sending DTX configuration.

FIG. 6 shows exemplary message flow for configuring CDRX configuration of UE.

FIG. 7 shows exemplary message flow for sending DTX configuration to Core Network (CN).

FIGS. 8-9 show exemplary message flows and procedures for sending UE data.

FIGS. 10A and 10B show exemplary message flows for sending DTX configuration.

FIG. 11 shows another exemplary message flow and procedure for sending UE data.

### DETAILED DESCRIPTION

### Wireless Communication Network

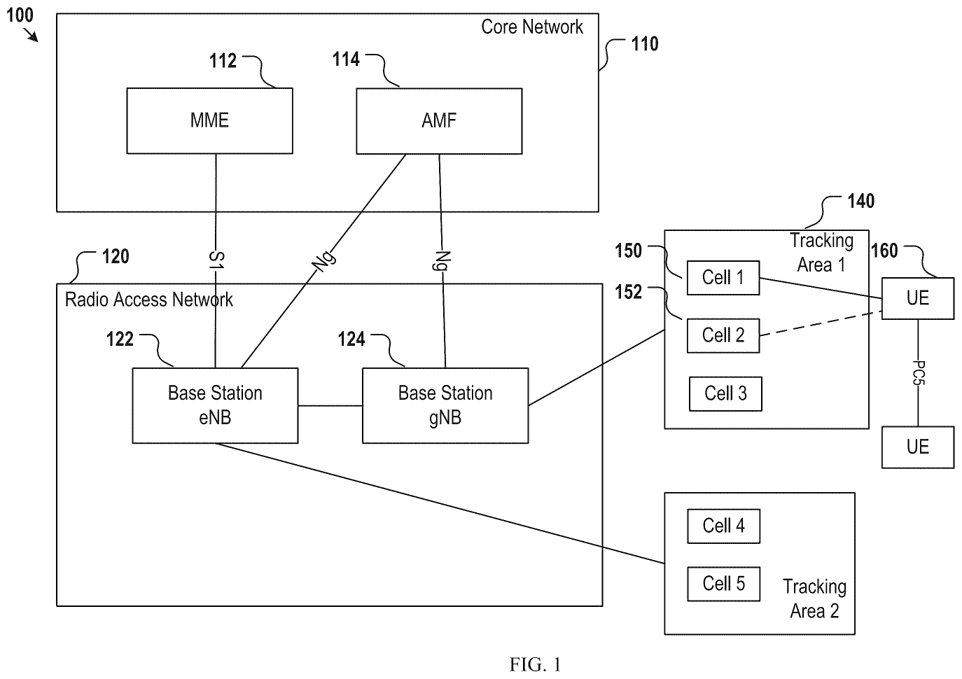

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

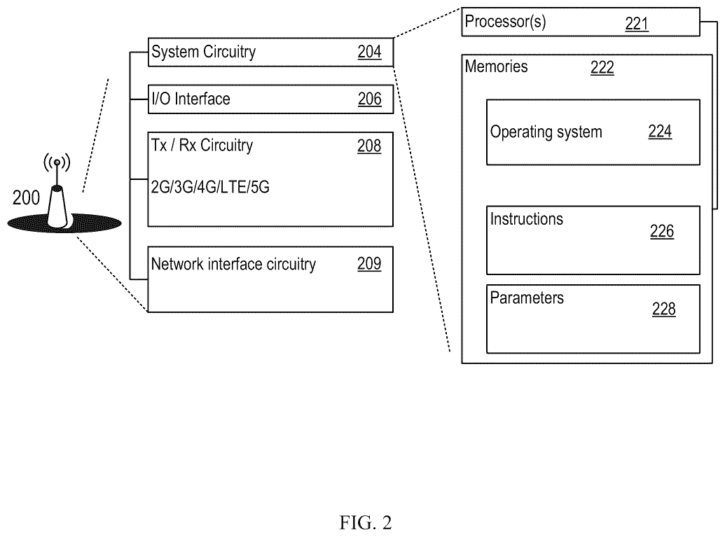

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

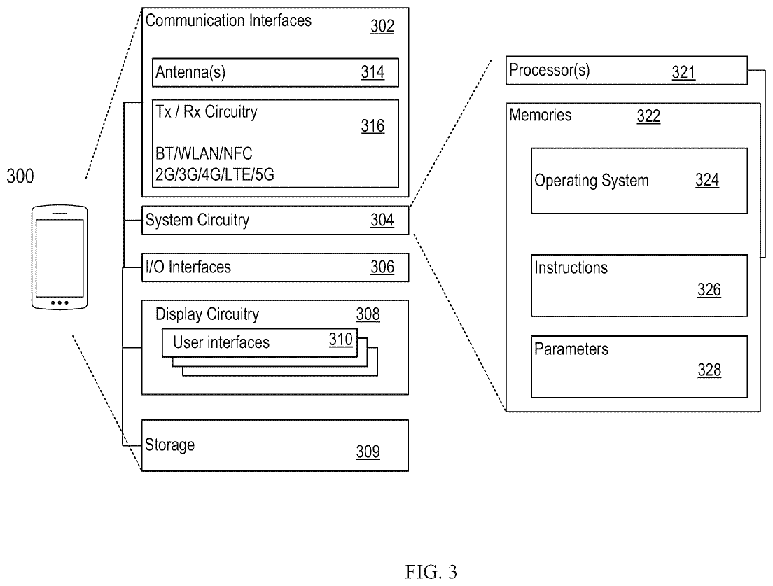

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### CDRX and DTX

In a wireless communication network, a UE may always listen/monitor the network (e.g., a base station) to check if there is new downlink data. The UE may also need to wait for uplink grant for transmitting uplink data. A notification for scheduled downlink data or uplink transmission grant may arrive through Physical Downlink Control Channel (PDCCH) that the UE needs to monitor. To always listen/monitor the network is not power efficient and would quickly drain the battery of the UE. For example, if the traffic for the UE is light, even there is no downlink reception or uplink transmission for the UE, the UE still need to keep awake to monitor the PDCCH. In order to reduce UE power consumption, the Connected mode Discontinuous Reception (CDRX) feature is introduced. When CDRX is configured for the UE, each CDRX cycle (may also be referred to as Discontinuous Reception (DRX) cycle) may include one “ON” period and one “OFF” period. The UE does not have to continuously monitor the PDCCH, but only monitors the PDCCH during the “ON” period, and switches to sleep mode during the “OFF” period. In the sleep mode, the UE may turn off certain hardware circuitries, such as Radio Frequency (RF) chain, to reduce power consumption.

The same concept may also apply to the base station side, as always staying in an “ON” state may be less power efficient. In order to reduce power consumption in the base station, the base station may transmit data to the UE discontinuously. For example, for a particular UE, the base station may transmit UE data during the “ON” period in the CDRX cycle of the UE. However, from the perspective of a cell serving the UE, since the cell may need to serve multiple UEs, and if the “ON” period for these UEs are not aligned, then the cell still needs to wake up frequently for data transmission at various “ON” period for these UEs. Therefore, the energy saving performance of the base station is sacrificed.

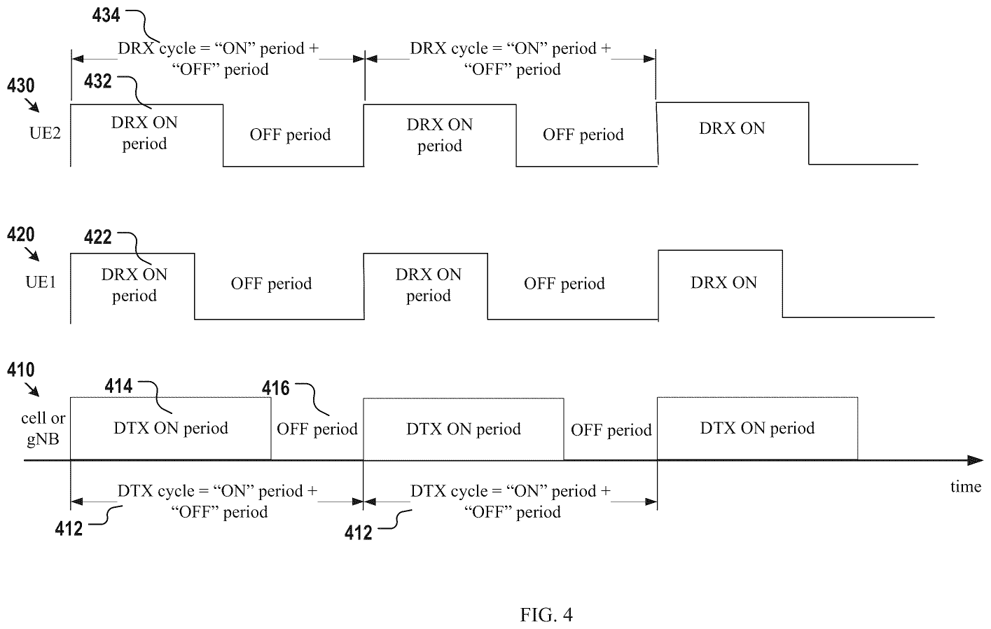

In order to further reduce the energy consumption of the gNB, in this disclosure, a Discontinuous Transmission (DTX) mode is introduced. The DTX mode may apply to various levels, such as a cell level, a cell group level, a DU level, a DU group level, or a whole base station level. Using cell as an example and with reference to FIG. 4, when the DTX mode is applied to the cell, the cell may be configured with a DTX cycle 412. Within each DTX cycle 412, there may be an “ON” period 414 and an “OFF” period 416. The cell may only transmit downlink data to its served UEs during the “ON” period, and suspend data transmission during the “OFF” period, to reduce power consumption.

When both CDRX of UE, and DTX of cell are applied, if the CDRX configuration for the UE and the DTX configuration for the cell are not determined with consideration to each other, there may be network performance issue. For example, in a worst case, if the “ON” duration for the cell has no overlap with the “ON” period for the UE, then data transmission to the UE may fail. This situation may be referred to as CDRX configuration and DTX configuration mismatch. To avoid this situation, coordination effort is required when determining the DTX configuration and/or CDRX configuration, so these two configurations match.

The DTX mode may also have implication for a base station using a distributed architecture, such as a gNB. In a gNB, the CU and the DU are separated, CU control plane (GNB-CU-CP) and CU user plane (gNB-CU-UP) may also be separated. Coordination effort between CU and DU, as well as gNB-CU-CP and gNB-CU-UP is required when configuring the DTX mode. The coordination effort may also need to consider the CDRX configuration for UE(s).

Further, if a cell is in energy saving mode during the DTX “OFF” period, it is beneficial for the cell to not receive UE data from the Core Network (CN), or another base station (e.g., in a dual connectivity scenario), otherwise, the cell may either need to frequently wake up to transmit the UE data, or the cell may need to buffer the received UE data and wait for the “ON” period to transmit. When the cell buffers the UE data, if the UE data is urgent or with a requirement for low latency, the UE data transmission may not meet the Quality of Service (QoS) requirement. Additionally, the buffering capacity of the cell, or the base station hosting the cell may be limited, an overflow condition may occur which may lead to data loss.

The above description uses cell as example. The same underlying concept may apply to a cell group, a DU, a DU group, and a base station.

In this disclosure, various embodiments are disclosed, aiming for reducing power consumption at a base station. These embodiments cover at least:
Configuring DTX for a cell, a cell group, a DU, a DU group, or a whole base station.
Configuring CDRX for a UE.
Sending or exchanging DTX configuration and/or CDRX configuration among various network elements.
End to end UE data transmission procedure based on DTX configuration and CDRX configuration.

Details on these embodiments are described below.

### Embodiment 1: UE DRX and Cell DTX Coordination

In a wireless communication network, a base station may manage or support multiple cells. A base station under a distributed architecture, such as a gNB, may distribute cells among DUs. Each cell may support or serve multiple UEs operating in connected state.

In this disclosure, for at least the purpose of saving energy consumption at a base station, a DTX mode is introduced. The DTX mode may apply to various levels targeting different granularities. For example, the DTX may apply to a cell level, a cell group level, a DU level, a DU group level, a base station level, or the like. In this disclosure, description may be made under the cell level for exemplary purpose. The same underlying principle applies to other levels as well.

The DTX mode may be configured by a DTX configuration. FIG. 4 illustrates an exemplary DTX configuration 410 for a cell (or a gNB, if DTX mode applies to the gNB level) serving UE1 and UE2. As shown in FIG. 4, a DTX configuration may include a DTX cycle 412. Within each DTX cycle, there is an ON period 414, during which the cell may transmit downlink data to its served UEs. Following the ON period 414 is the OFF period 416, during which the cell does not transmit downlink data. The OFF period 416 may be considered as a power saving period or low energy consumption period for the cell, as related hardware, such as radio frequency chain, transmit (TX) circuitry, etc., may be turned off to save power.

In one implementation, an ON period in a DTX cycle may be indicated, tracked, or associated with a timer, such as an onDuration Timer.

In one implementation, an OFF period in a DTX cycle may be indicated, or associated with a timer, such as an offDuration Timer.

In one implementation, a list of DTX configurations may be configured as candidate configurations. ADTX configuration may be selected from this list and activated/applied, for example, via signaling, or based on predetermine rules.

In one implementation, the DTX mode may be applied to the DU level. In this case, a single DTX configuration may be configured at the DU level, and the DTX configuration may be applied to all cells managed or supported by the DU.

In one implementation, the DTX mode may be applied or activated when a predetermined condition is met. For example, when a number of UEs served by the cell is lower or higher than a threshold, the DTX mode may be applied. The threshold may be signaled or predefined. For another example, a certain DTX configuration may be selected based on the number of UEs served by the cell.

As described above, the DTX mode may determine the on/off behavior of a cell, a group of cells, a DU, a group of DUs, or a base station, depending on what level the DTX mode is applied to. Using cell as an example, the DTX configuration of a cell may need to be coordinated with a CDRX configuration of a UE served by the cell, to ensure the UE is awake when the cell is transmitting data to the UE when the cell is in a DTX “ON” period.

In exemplary implementations, the base station may configure the CDRX configuration of the UE according to the DTX configuration of UE's serving cell, such that the DRX ON period of a UE is fully aligned, or partially aligned with the DTX ON period of the serving cell of UE. FIG. 4 illustrates an example CDRX configuration 420 for UE1 and its relationship with the DTX configuration 410. For UE1, the DRX ON period 422 is within the duration of DTX ON period 414 of the cell serving UE1. In example shown in FIG. 4, DRX ON period 422 and DTX ON period 414 starts at same time point. The whole DRX ON period 422 overlaps with DTX ON period 414. Not shown in FIG. 4, in alternative implementations, the DRX ON period and DTX ON period may start at different time point. Not shown in FIG. 4, DRX ON period of a UE may partially overlap with the DTX ON period of the cell serving the UE.

FIG. 4 further illustrates an example CDRX configuration 430 for UE2. UE2 has a DRX ON period 432 which is also within the duration of DTX ON period 414 of the cell. As shown in FIG. 4, 432 lasts longer than 422.

As shown in FIG. 4, the CDRX configuration of a UE is correlated with the DTX configuration of a cell (or a group of cells, a DU, a gNB, etc.).

As can be seen from FIG. 4, the cell may transmit downlink data to UE1 during 422, and transmit downlink data to UE2 during 432. The cell may switch to power saving mode in the OFF period 416, to reduce power consumption. According to example embodiments, the CDRX configuration, or a portion of the CDRX configuration of a UE may be determined according to the DTX configuration of UE's serving cell.

In some example implementations, the DRX ON period of the UE (e.g., 422, 432) may be configured directly based on the DTX configuration of UE's serving cell.

In some other example implementations, the DRX ON period (e.g., 422, 432) may be indirectly determined by, or may rely on, one or more other CDRX configuration parameters. To satisfy the ON periods (i.e., DRX ON period of UE, and DTX ON period of cell) alignment requirement as described above, at least one of the following CDRX configuration parameters may need to be configured according to the DTX configuration of UE's serving cell:
DRX Cycle: The duration of “DRX ON period” + “DRX OFF period”, as the DRX cycle 434 shown in FIG. 4. A DRX cycle may also be referred to as a CDRX cycle.
shortDRX-Cycle: DRX cycle which may be implemented within the “OFF” period of a long DRX cycle.
onDurationTimer: A timer which indicates the duration of ‘ON time’ within one DRX cycle.
drx-Inactivity timer: This parameter may specify how long UE should remain ‘ON’ after the reception of a Physical Downlink Control Channel (PDCCH).
drx-Retransmission timer: This parameter may specify the maximum number of consecutive PDCCH subframes the UE should remain active to wait an incoming retransmission after the first available retransmission time.
drxShortCycleTimer: The consecutive number of subframes the UE shall follow (or apply) the short DRX cycle after the DRX Inactivity Timer has expired.

It should be noted that, these parameters are for exemplary purpose only. In practical applications, parameters with different names but with similar functionalities may be chosen and may be configured according to the DTX configuration of UE's serving cell, to satisfy the ON periods alignment requirement.

In some example implementations, at least partial of the DTX configuration and at least partial of the CDRX configuration may be determined by the CU of a base station.

In some other example implementations, at least partial of the DTX configuration and at least partial of the CDRX configuration may be determined by the DU of a base station.

### Embodiment 2: Configure DTX via F1 Interface

As shown in FIG. 4 and explained in embodiment 1, the CDRX configuration of a UE is correlated with the DTX configuration of a cell. Therefore, when the wireless communication network determines the CDRX configuration for a UE, the DTX configuration of UE's serving cell may need to be referenced; and/or when the wireless communication network determines the DTX configuration for a cell, the CDRX configuration of a UE served by the cell may need to be referenced.

Further, for a base station under a distributed architecture, such as a gNB, the CU and DU may need to communicate with each other to exchange DTX configuration (e.g., for a cell, a group of cells, etc.), and/or CDRX configuration of a UE.

For example, the CDRX configuration, including DRX cycle of a UE, may be configured by the CU. Therefore, the CU may need to be aware of the DTX configuration of the UE's serving cell, so CU may configure the CDRX configuration of a UE to be aligned with the DTX configuration.

On the other hand, in order to save power consumption, the DU may discontinuously transmit data to the UE according to the DTX configuration of the UE's serving cell. In doing so, the DU may need to be aware of the DTX configuration of the UE's serving cell.

In this embodiment, various options are described for exchanging DTX configuration between CU and DU.

### Option 1: DU Configures DTX Configuration

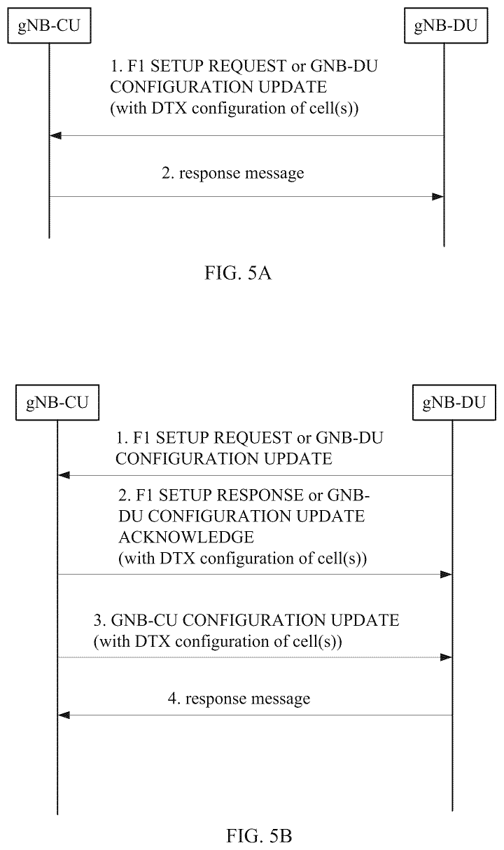

FIG. 5A illustrates message flow and network elements interaction for option 1.

### Step 1:

The DU may configure or determine the DTX configuration for a cell in the DU (i.e., a cell managed by, or supported by the DU), and send a message, such as an F1 SETUP REQUEST message, or a GNB-DU CONFIGURATION UPDATE message, to the CU, to transfer or update configuration data required by CU and DU. The configuration data required may include DTX configuration of a cell, a group of cells served by the DU, and the like.

It should be noted that, the DU may only be able to send the GNB-DU CONFIGURATION UPDATE message to the CU after the F1 interface between CU and DU has been established.

### Step 2:

The CU may send a response message to the DU.

### Option 2: CU Configures DTX Configuration

FIG. 5B illustrates message flow and network elements interaction for option 2.

### Step 1:

DU may send a message, such as an F1 SETUP REQUEST message, or a GNB-DU CONFIGURATION UPDATE message, to the CU, to transfer or update configuration data required by CU and DU (note that the configuration data in this step does not include DTX configuration in this step).

It should be noted that, the DU may only be able to send the GNB-DU CONFIGURATION UPDATE message to the CU after the F1 interface between CU and DU has been established.

### Step 2:

CU may configure or determine DTX configuration for one or more active cell at DU. CU may then send a message, such as an F1 SETUP RESPONSE message, or a GNB-DU CONFIGURATION UPDATE ACKNOWLEDGE message, to the DU. The message may include DTX configuration of active cell(s) under the DU. In some implementations, the message may include DTX configuration of all cells (i.e., not only active cells) under the DU.

### Step 3:

This step is optional. After the F1 interface has been established, if the CU updates the DTX configuration for a cell, or an active cell under the DU, the CU may send a message, such as a GNB-CU CONFIGURATION UPDATE message to the DU. The message may include DTX configuration of the cell or the active cell.

### Step 4:

The DU may send a response message to the CU, as a response to the message in

### Step 3.

As described earlier, the DTX configuration may apply to various levels targeting different granularities. For example, the DTX configuration may apply to a cell level, a gNB level, and the like. For a gNB level DTX configuration, the gNB may configure a same DTX configuration for all its cells. For example, the DTX configuration may be configured for the gNB, and then be applied to all cells in the gNB. In some implementations, not all cells under the gNB support DTX mode. In this case, the DTX configuration may be applied to all cells which support DTX mode.

In some implementations, there may be an override mechanism. The gNB may be configured with a gNB level DTX configuration which may be applied to all its cells. A cell under the gNB may be further provided with a different DTX configuration which may be used to override the gNB level DTX configuration.

### Embodiment 3: Configure CDRX for UE

This embodiment describes the interaction between DU, CU and UE, for determining and configuring CDRX configuration of the UE.

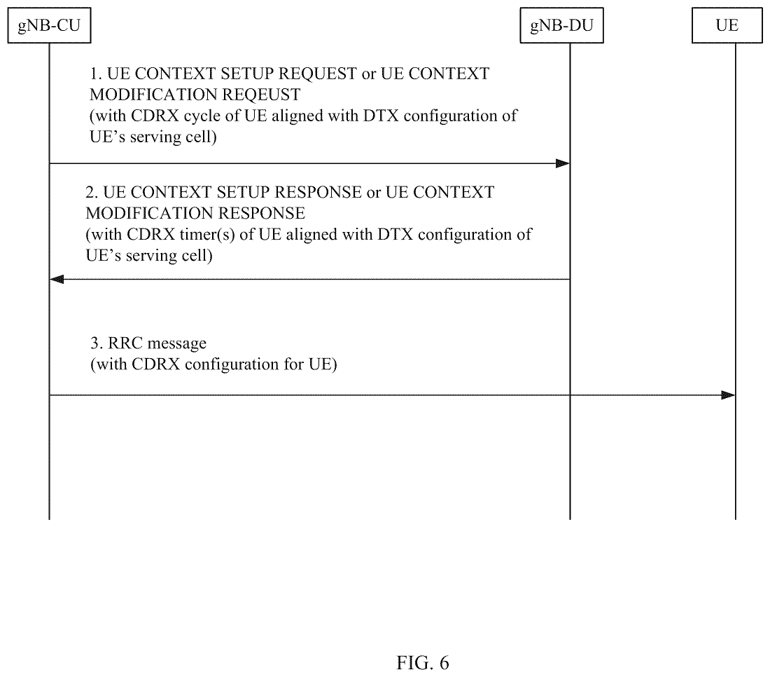

FIG. 6 illustrates message flow and network elements interaction for this embodiment.

### Step 1:

The CU is aware of the DTX configuration of the cell(s) under the DU. Therefore, the CU may determine the DRX cycle for the UE according to the DTX configuration of the UE's serving cell, such that the DRX cycle of the UE is aligned with DTX cycle of UE's serving cell. The DRX cycle is part of the CDRX configuration of the UE and may be represented in number of frames, subframes, slots, symbols, and the like.

The CU may send a UE context related message, such as a UE CONTEXT SETUP REQUEST message, or a UE CONTEXT MODIFICATION REQUEST message, to the DU, to establish or modify UE context of the UE. The UE context may include the DRX cycle of the UE.

In some example implementations, as an alternative for sending DTX configuration of a cell to the DU, the UE context related messages may also be used by the CU to send DTX configuration to the DU, as compared with using the F1 interface setup/modify procedure to send DTX configuration (described in embodiment 2).

### Step 2:

The DU may configure or determine rest of the CDRX configuration (as DRX cycle is sent to DU in step 1) for the UE according to both the DTX configuration of the UE's serving cell, and DRX cycle of the UE. The DU may then send a response message, such as a UE CONTEXT SETUP RESPONSE message, or a UE CONTEXT MODIFICATION RESPONSE message to the CU, the response message including the CDRX configuration (with or without the DRX cycle) for the UE. In some implementations, the CDRX configuration may be wrapped or encapsulated in a Radio Resource Control (RRC) container.

### Step 3:

The CU may send the CDRX configuration of the UE to the UE via an RRC message.

### Embodiment 4: Base Station Transmits DTX Configuration to Core Network (CN)

This embodiment describes the message flow between the base station and the CN, for passing DTX configuration. The CN may generally refer to a core network, or a node within the core network. The DTX configuration may be per cell, per cell group, per DU, per DU group, per base station, and the like.

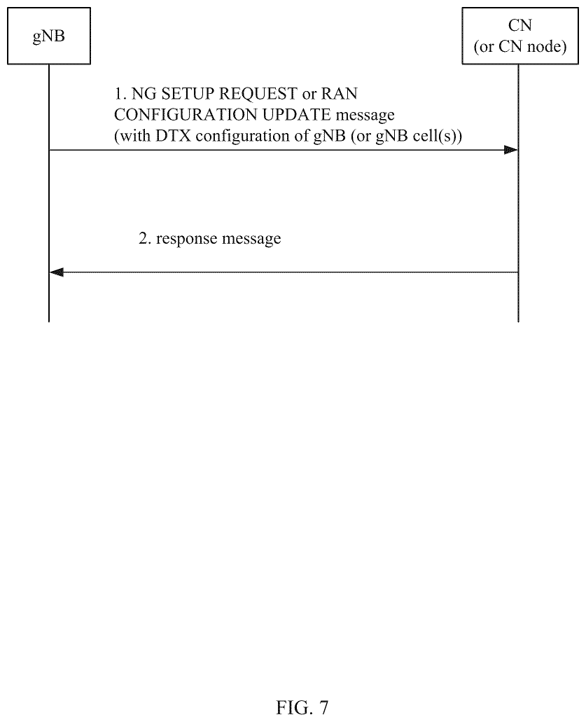

FIG. 7 illustrates an exemplary message flow for this embodiment.

If a cell is in energy saving mode during the DTX “OFF” period, it is beneficial for the cell to not receive UE data from the CN. Otherwise, the cell may either need to frequently wake up to transmit the UE data, or the cell may need to buffer the received UE data and wait for the DTX “ON” period to transmit. When the cell buffers the UE data, if the UE data is urgent or with a requirement for low latency, the UE data transmission may not meet the Quality of Service (QOS) requirement. Additionally, the buffering capacity of the cell, or the base station hosting the cell may be limited, an overflow condition may occur which may lead to data loss. Therefore, the CN needs to be aware of the DTX configuration of the cell, to determine the timing for forwarding UE data to the gNB/cell. In this embodiment, a solution is provided for transmitting the DTX configuration to the CN via NG interface setup/modification procedure.

### Step 1:

The base station (e.g., gNB) may configure the DTX configuration for its cell(s) and send a message, such as an NG SETUP REQUEST message, or a RAN CONFIGURATION UPDATE message to the CN, to transfer or update configuration data required by the base station and the CN. The message may include the DTX configuration of cell(s) under the base station.

### Step 2:

The CN may send a response message to the base station, a response to the message in step 1.

As described earlier, the DTX configuration may apply to various levels targeting different granularities. For example, the DTX configuration may apply to a cell level, a gNB level, and the like. For a gNB level DTX configuration, the gNB may configure a same DTX configuration for all its cells. For example, the DTX configuration may be configured for the gNB, and then be applied to all cells in the gNB. In this case, only the gNB level DTX configuration may need to be sent to the CN.

### Embodiment 5: End to End Discontinuous Data Transmission Procedure

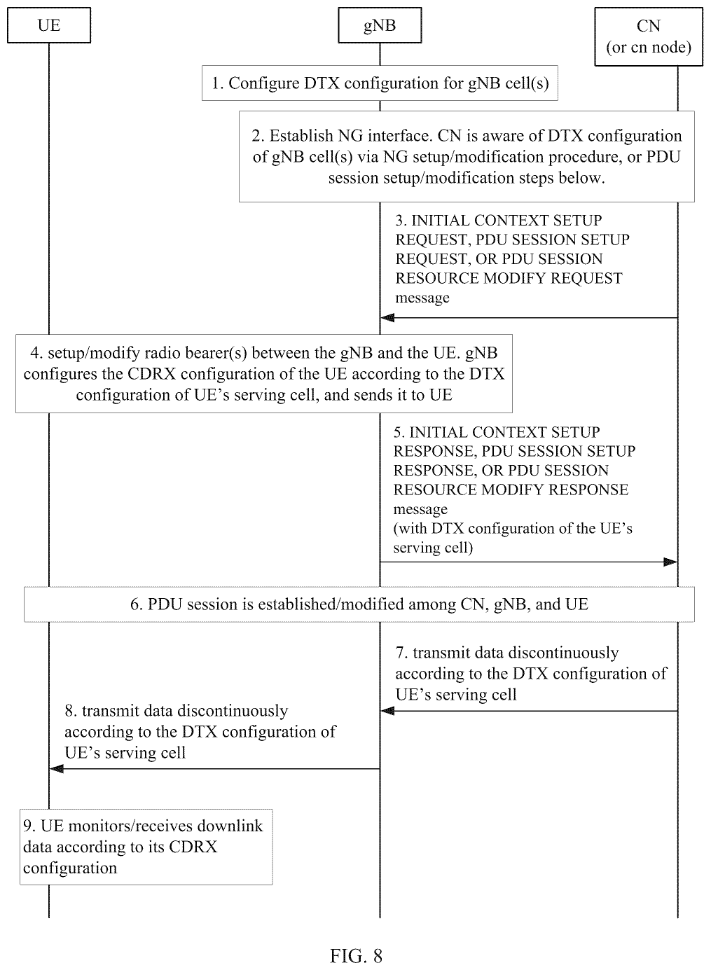

This embodiment describes an end to end data transmission procedure based on DTX configuration of a cell and CDRX configuration of a UE served by the cell. Refer to FIG. 8 for exemplary message flow and interaction between various network elements.

### Step 1:

The gNB may configure the DTX configuration for gNB cell(s).

### Step 2:

In this step, the NG interface between the CN and the gNB is established, and CN may become aware of the DTX configuration of gNB cell(s) by, for example, NG setup/modification procedure described in embodiment 4.

### Step 3:

The CN may send a message, such as an INITIAL CONTEXT SETUP REQUEST message, or a Protocol Data Unit (PDU) SESSION SETUP REQUEST message to gNB, to request assigning resources for one or more PDU session for a UE.

If the PDU session is already setup, the CN may send a PDU SESSION RESOURCE MODIFY REQUEST message to request modifying the existing PDU session resources for a UE.

### Step 4:

The Radio Bearer(s) (RBs) between the gNB and the UE may be setup or modified in this step.

The gNB may configure the CDRX configuration of the UE according to the DTX configuration of the UE's serving cell, and then send it to UE via an RRC message.

### Step 5:

The gNB may send a response message, such as an INITIAL CONTEXT SETUP RESPONSE message, a PDU SESSION SETUP RESPONSE message, or a PDU SESSION RESOURCE MODIFY RESPONSE message to the CN, as a response to the message sent to gNB in step 3. The response message may include the DTX configuration of the UE's serving cell.

As describe earlier in embodiment 4, the gNB may send the DTX configuration of cell(s) to the CN via NG interface setup/modification procedure. This step in current embodiment introduces an alternative way for the gNB to send the DTX configuration to the CN by using the response message.

### Step 6:

The PDU session is established/modified among CN, gNB, and UE.

### Step 7:

The CN discontinuously transmits UE data to the gNB according to the DTX configuration of UE's serving cell. In other words, if a cell is in energy saving mode during the DTX “OFF” period, the CN may suspend sending data to the gNB. The CN may only send data to the gNB during the DTX “ON” period of the cell. Under this discontinuous transmission mechanism, the cell may be eased from frequently waking up to transmit data, and/or the cell may not need to buffer the received UE data and wait for the “ON” period to transmit to the UE, therefore solving the data loss issue caused by cell/gNB buffer overflow.

### Step 8:

Similarly, the gNB may transmit the UE data to the UE according the DTX configuration of the UE's serving cell. In other words, the gNB only transmits downlink data to the UE during the DTX “ON” period of the cell, and switch to energy saving state during the “OFF” period of the cell. In this way, the goal for energy saving may be achieved at a cell level. Similarly, the DTX mode may be applied to a group of cells, a DU, a group of DUs, or the whole gNB, and power saving may be achieved at a corresponding level.

### Step 9:

The UE monitors/receives downlink data according its CDRX configuration, which is aligned with the DTX configuration of its serving cell.

### Embodiment 6: Assisting gNB Discontinuous Data Transmission Procedure

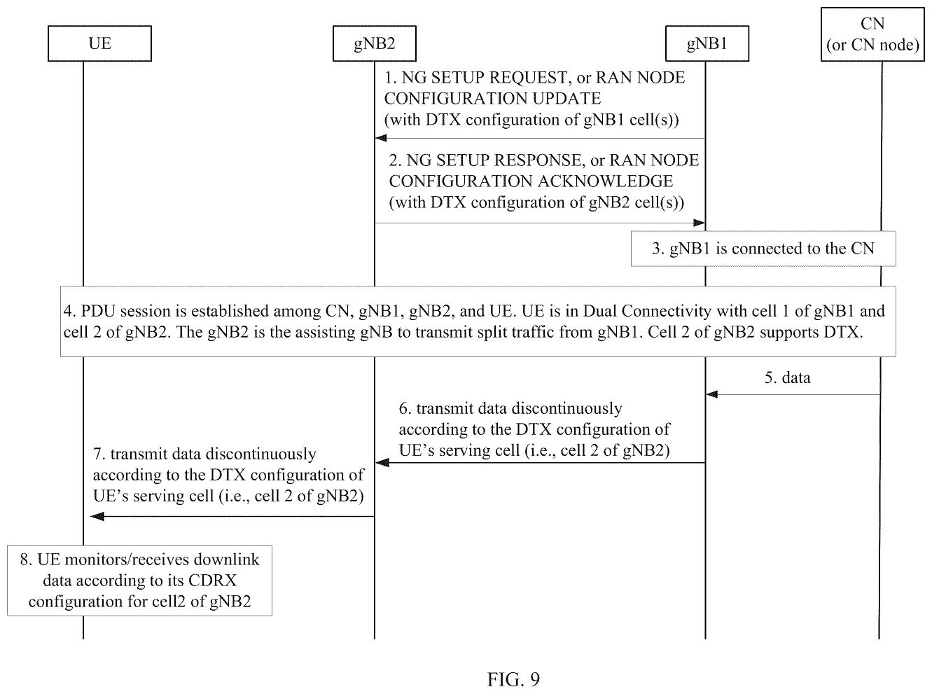

This embodiment describes an end to end data transmission procedure based on DTX configuration of a cell and CDRX configuration of a UE served by the cell. Refer to FIG. 9 for exemplary message flow and interaction between various network elements. In this embodiment, the UE has a dual connectivity with gNB1 and gNB2.

### Step 1:

During the Xn interface setup/modification phase, the gNB1 may send a message, such as an NG SETUP REQUEST message, or a RAN NODE CONFIGURATION UPDATE message to gNB2, to setup or modify the Xn interface between gNB1 and gNB2. The message may include the DTX configuration of a cell (or cells) under gNB1.

### Step 2:

The gNB2 may send a response message, such as an NG SETUP RESPONSE message, or a RAN NODE CONFIGURATION ACKNOWLEDGE message to gNB1. The response message may include the DTX configuration of a cell (or cells) under gNB2.

### Step 3:

The gNB1 is connected with the CN.

### Step 4:

A PDU session is established among CN, gNB1, gNB2, and UE. The UE is under Dual Connectivity (DC) with cell1 (in gNB1) and cell2 (in gNB2). In this case, the gNB2 acts as an assisting gNB in the sense that the gNB2 transmits the split traffic from the gNB1 (i.e., gNB1 may offload some traffic for UE to gNB2). Note that cell2 of gNB2 supports the DTX mode.

### Step 5:

CN sends UE data to the connected base station, which is gNB1 (see step 3).

### Step 6:

The gNB1 may discontinuously transmit UE data to the gNB2 according to the DTX configuration of UE's serving cell, which is cell2 of gNB2. In other words, if cell2 is in energy saving mode during the DTX “OFF” period, the gNB1 may suspend sending data to cell2. The gNB1 only sends data to cell2 during the DTX “ON” period of cell2. Under this discontinuous transmission mechanism, cell2 may be eased from frequently waking up to transmit data, and/or cell2 may not need to buffer the received UE data and wait for the “ON” period to transmit to the UE, therefore solving the data loss issue caused by cell2/gNB2 buffer overflow.

### Step 7:

Similarly, the gNB2 may transmit the UE's data to UE according the DTX configuration of the UE's serving cell, which is cell2 of gNB2. In other words, the gNB2 may only transmit downlink data to the UE during the DTX “ON” period of cell2, and switch to energy saving state during the DTX “OFF” period of cell2. In this way, the goal for energy saving may be achieved at a cell level (i.e., cell2). Similarly, the DTX mode may be applied to a group of cells, a DU, a group of DUs, or the whole gNB, and power saving may be achieved at a corresponding level.

### Step 8:

The UE monitors/receives downlink data according its CDRX configuration with cell2. In some example implementations, a UE may be configured with multiple CDRX configurations. For example, UE may apply/activate a CDRX configuration for each cell it connects with. For example, UE may apply a first CDRX configuration to a first cell it connects with, and may apply a second CDRX configuration to a second cell it connects with.

### Embodiment 7: DTX Configuration for gNB-CU-UP

For a base station such as a gNB, the CU and the DU may be separated. The CU may be further separated into two nodes (gNB-CU-CP and gNB-CU-UP, respectively) corresponding to a control plane and a user plane, respectively. These two nodes may be in the form of physical node, or logical node.

If a cell is in energy saving mode during the DTX “OFF” period, it is beneficial for the cell to not receive UE data from gNB-CU-UP. Otherwise, the cell may either need to frequently wake up to transmit the UE data, or the cell may need to buffer the received UE data and wait for the DTX “ON” period to transmit. When the cell buffers the UE data, if the UE data is urgent or with a requirement for low latency, the UE data transmission may not meet the QoS requirement. Additionally, the buffering capacity of the cell, or the base station hosting the cell may be limited, an overflow condition may occur which may lead to data loss. Therefore, the gNB-CU-UP may need to be aware of the DTX configuration of the cell in order to transmit UE data to the DU accordingly. In this embodiment, two options are provided for transmitting the DTX configuration to gNB-CU-UP.

### Option 1:

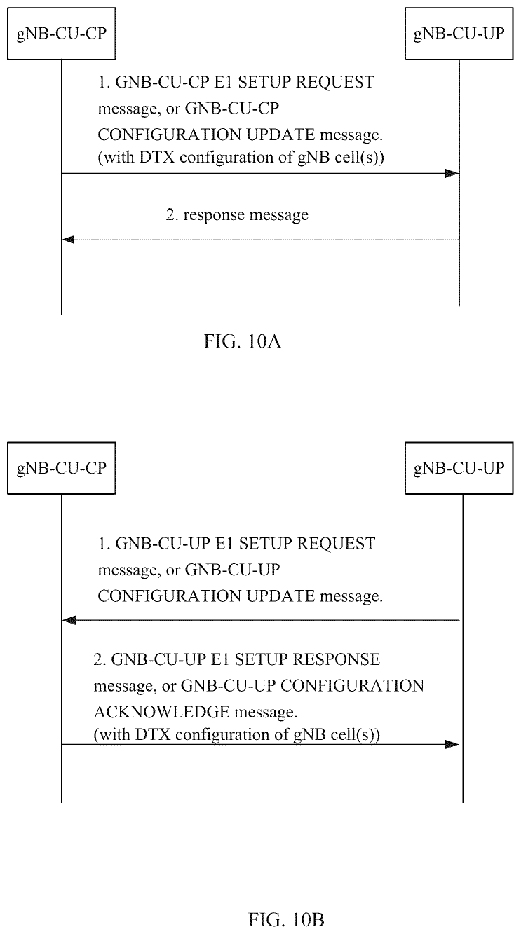

Refer to FIG. 10A for exemplary message flow between gNB-CU-CP and gNB-CU-CP-UP for transferring DTX Configuration.

### Step 1:

The gNB-CU-CP may send a message, such as a GNB-CU-CP E1 SETUP REQUEST message, or a GNB-CU-CP CONFIGURATION UPDATE message to gNB-CU-UP, to transfer or update configuration data required for the gNB-CU-CP and the gNB-CU-UP. The configuration data may include DTX configuration of gNB cell(s).

### Step 2:

The gNB-CU-UP may send a response message to the gNB-CU-CP.

### Option 2:

Refer to FIG. 10B for exemplary message flow between gNB-CU-CP and gNB-CU-CP-UP for transferring DTX Configuration.

### Step 1:

The gNB-CU-UP may send a message, such as a GNB-CU-UP E1 SETUP REQUEST message, or a GNB-CU-UP CONFIGURATION UPDATE message to gNB-CU-CP, to transfer or update configuration data required for the gNB-CU-CP and the gNB-CU-UP.

### Step 2:

The gNB-CU-CP may send a response message, such as a GNB-CU-UP E1 SETUP RESPONSE message, or a GNB-CU-UP CONFIGURATION ACKNOWLEDGE message to gNB-CU-UP, to transfer or update configuration data required for the gNB-CU-CP and the gNB-CU-UP. The configuration data may include DTX configuration of gNB cell(s).

### Embodiment 8: Exemplary Discontinuous Data Transmission Procedure

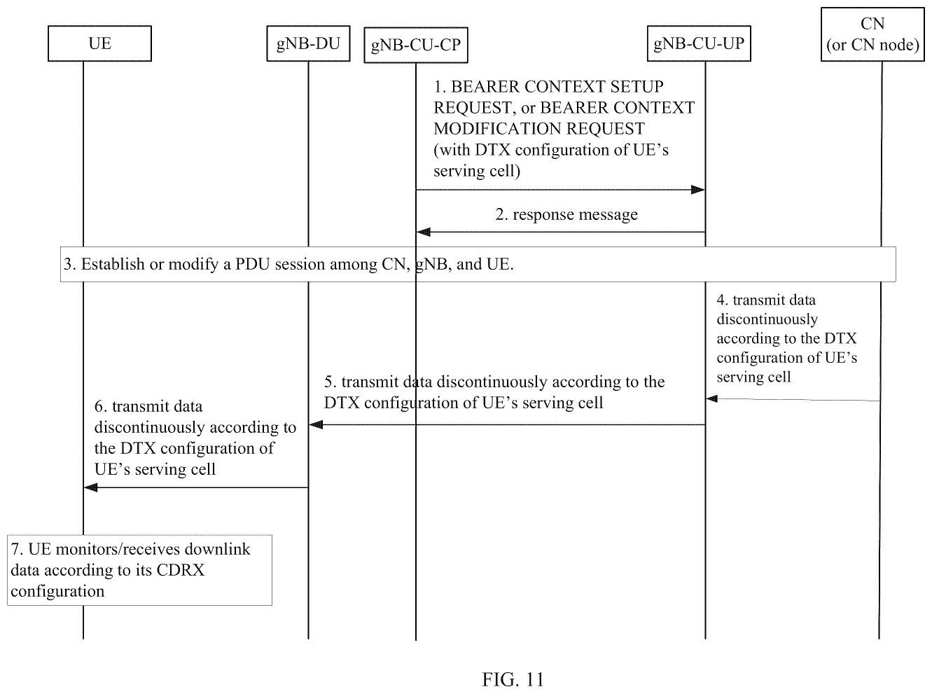

This embodiment shows an end to end UE data transmission procedure in which the gNB-CU-CP and the gNB-CU-UP are separated. Refer to FIG. 11 for exemplary message flow and interaction between various network elements.

### Step 1:

The gNB-CU-CP may send a message, such as a BEARER CONTEXT SETUP REQUEST message, or a BEARER CONTEXT MODIFICATION REQUEST message to gNB-CU-UP, to setup or modify a bearer context for the UE. The message may include the DTX configuration of UE's serving cell.

It is to be noted that, as an alternative for sending DTX configuration of a cell to gNB-CU-UP, the gNB-CU-CP may send the DTX configuration to gNB-CU-UP using the aforementioned bearer context related message, when setting up or modifying the UE bearer at the gNB-CU-UP.

### Step 2:

The gNB-CU-UP may send a response message to the gNB-CU-CP.

### Step 3:

In this step, a PDU session associated with the bearer context may be established (if not yet exists), or modified (if already exists). As shown in FIG. 11, the PDU session may be among CN, gNB (include gNB-DU, gNB-CU-CP, and gNB-CU-UP), and UE.

### Step 4:

CN may discontinuously transmit UE data to the gNB-CU-UP according to the DTX configuration of UE's serving cell.

### Step 5:

Similarly, the gNB-CU-UP may transmit the UE data to DU according the DTX configuration of UE's serving cell. That is, the gNB-CU-UP may only transmit UE downlink data to the DU during the DTX “ON” period of the serving cell of UE.

### Step 6:

The DU may transmit UE data to the UE according the DTX configuration of the UE's serving cell (managed by the DU). That is, the DU may only transmit downlink data to the UE during the DTX “ON” period of the serving cell, and switch to energy saving state during the DTX “OFF” period of UE's serving cell. In this way, the goal for energy saving may be achieved.

### Step 7:

UE monitors/receives downlink data according its CDRX configuration.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a first network element, the method comprising:
providing, to a second network element, a Discontinuous Transmission (DTX) configuration for a cell associated with the second network element, wherein the DTX configuration comprises at least one of: a DTX cycle; or a duration of an on time within the DTX cycle;
providing, to a wireless device served by the cell and based on the DTX configuration, a Connected mode Discontinuous Reception (CDRX) configuration for the wireless device, wherein the CDRX configuration comprises at least one of:
a Discontinuous Reception (DRX) cycle;
a short DRX cycle which is with an off period of a long DRX cycle;
a duration of an on time within the DRX cycle;
a duration that the wireless device stays in an on state after a reception of a Physical Downlink Control Channel (PDCCH);
a maximum duration that the wireless device stays in an active state to wait for a retransmission after a first available retransmission time; or
a DRX short cycle timer; and
transmitting data to the wireless device according to the DTX configuration, or transmitting the data to the wireless device via a second base station according to the CDRX configuration.

2. The method of claim 1, further comprising:
determining the DTX configuration for the cell; and
determining the CDRX configuration for the wireless device based on the DTX configuration, such that an on period of the cell according to the DTX configuration is fully aligned or partially aligned with an on period of the wireless device according to the CDRX configuration.

3. The method of claim 2, wherein a start of the on period of the cell is aligned with a start of the on period of the wireless device.

4. The method of claim 2, wherein a portion of a duration of an on period of the wireless device overlaps with a duration of an on period of the cell, or a whole duration of the on period of the wireless device overlaps with the duration of the on period of the cell.

5. The method of claim 1, wherein:
the first network element comprises a Distributed Unit (DU) of a first base station, the second network element comprises a Central Unit (CU) of the first base station, and the cell is managed by the first network element; or
the first network element comprises the CU of the first base station, the second network element comprises the DU of the first base station, and the cell is managed by the second network element.

6-7. (canceled)

8. The method of claim 1, wherein the duration of the on time within the DTX cycle is associated with an on duration timer.

9-10. (canceled)

11. The method of claim 1, wherein:
the first network element comprises a DU of a first base station, the second network element comprises a CU of the first base station, and the cell is managed by the first network element; and
providing, to the second network element, the DTX configuration comprises:
transmitting, to the second network element, a first message comprising the DTX configuration, wherein the first message comprises at least one of:
an F1 SETUP REQUEST message; or
a GNB-DU CONFIGURATION UPDATE message.

12. The method of claim 1, wherein:
the first network element comprises a CU of a first base station, the second network element comprises a DU of the first base station, and the cell is managed by the second network element; and
providing, to the second network element, the DTX configuration comprises:
receiving, from the second network element, a first message comprising at least one of:
an F1 SETUP REQUEST message; or
a GNB-DU CONFIGURATION UPDATE message; and
transmitting, to the second network element, a response message to the first message, the response message comprising the DTX configuration.

13. The method of claim 1, wherein:
the first network element comprises a CU of a first base station, the second network element comprises a DU of the first base station, and the cell is managed by the second network element; and
providing, to the second network element, the DTX configuration comprises:
transmitting, to the second network element, a first message comprising the DTX configuration, the first message comprising at least one of:
a GNB-CU CONFIGURATION UPDATE message;
a UE CONTEXT SETUP REQUEST message; or
a UE CONTEXT MODIFICATION REQUEST message.

14. The method of claim 1, wherein:
the first network element comprises a CU of a first base station, the second network element comprises a DU of the first base station, and the cell is managed by the second network element; and
providing, to the wireless device served by the cell and based on the DTX configuration, the CDRX configuration for the wireless device comprises:
determining a partial of the CDRX configuration;
transmitting the partial of the CDRX configuration to the second network element via a first message, the first message comprising at least one of:
a UE CONTEXT SETUP REQUEST message; or
a UE CONTEXT MODIFICATION REQUEST message; and
receiving, from the second network element, a response message to the first message comprising the CDRX configuration, wherein the CDRX configuration is based on the partial of the CDRX configuration, and the response message comprises at least one of:
a UE CONTEXT SETUP RESPONSE; or
a UE CONTEXT MODIFICATION RESPONSE message.

15. The method of claim 14, wherein the partial of the CDRX configuration comprises a CDRX cycle, and at least a portion of the CDRX configuration is determined by the second network element based on the partial of the CDRX configuration.

16. A method for wireless communication, performed by a first node in a network element, the method comprising:
receiving, from a second node in the network element, a first message comprising a DTX configuration for a cell managed by the network element; and
transmitting data to a wireless device, via a relay of a DU of the network element and according to the DTX configuration, the wireless device being served by the cell.

17. The method of claim 16, wherein:
the network element comprises a base station;
the first node comprises a gNB-CU-UP node; and
the second node comprises a gNB-CU-CP node.

18. The method of claim 16, wherein the first message comprises at least one of:
a GNB-CU-CP E1 SETUP REQUEST message; or
a GNB-CU-CP CONFIGURATION UPDATE message.

19. The method of claim 16, wherein receiving, from the second node in the network element, the first message comprises:
transmitting a second message to the second node, wherein the second message comprises at least one of: a GNB-CU-UP E1 SETUP REQUEST message; or a GNB-CU-UP CONFIGURATION UPDATE message; and
receiving, from the second node in the network element, the first message as a response to the second message, the first message comprising the DTX configuration for the cell managed by the network element.

20. (canceled)

21. The method of claim 16, wherein the first message is associated with a context of the wireless device and comprises at least one of:
a BEARER CONTEXT SETUP REQUEST message; or
a BEARER CONTEXT MODIFICATION REQUEST message.

22. The method of claim 21, wherein:
the network element comprises a base station;
the first node comprises a gNB-CU-UP node; and
the method further comprises: transmitting the data to a DU of the base station according to the DTX configuration.

23. The method of claim 22, wherein transmitting the data to the wireless device comprises:
transmitting the data to the DU according to the DTX configuration, wherein a reception of the data by the DU triggers the DU to transmit the data to the wireless device according to the DTX configuration.

24-33. (canceled)

34. A first node in a network element, the first node comprising a memory for storing computer instructions and a processor in communication with the memory, wherein, when the processor executes the computer instructions, the processor is configured to cause the first node to:
receive, from a second node in the network element, a first message comprising a Discontinuous Transmission (DTX) configuration for a cell managed by the network element; and
transmit data to a wireless device, via a relay of a DU of the network element and according to the DTX configuration, the wireless device being served by the cell.

35. A first network element for wireless communication comprising a memory for storing computer instructions and a processor in communication with the memory, wherein, when the processor executes the computer instructions, the processor is configured to implement a method in claim 1.
